(19) United States
(12) Patent Application Publication
(10) Pub. No.: US 2023/0378573 A1
(43) Pub. Date: Nov. 23, 2023

(54) SYSTEMS AND METHODS FOR SAFE AND FLEXIBLE BATTERIES

(71) Applicant: The Johns Hopkins University, Baltimore, MD (US)

(72) Inventors: Nicholas G. Pavlopoulos, Columbia, MD (US); Jason E. Tiffany, Columbia, MD (US); Spencer A. Langevin, Silver Spring, MD (US)

(73) Assignee: The Johns Hopkins University, Baltimore, MD (US)

(21) Appl. No.: 18/322,237

(22) Filed: May 23, 2023

Related U.S. Application Data
(60) Provisional application No. 63/344,758, filed on May 23, 2022.

(51) Int. Cl. H01M 50/105; H01M 50/178; H01M 50/131; H01M 50/121

(52) U.S. Cl. CPC H01M 50/105; H01M 50/178; H01M 50/131; H01M 50/121

(57) ABSTRACT

Disclosed herein is an electronic device encapsulation including a non-permeable coating and at least one pair of leads coupled to an electronic device protruding from the non-permeable coating. Also disclosed herein is a method of encapsulating an electronic device including attaching at least a pair of electric leads to the device, coating the device and a portion of each lead with a non-permeable coating, and curing the non-permeable coating. Further disclosed is an encapsulated system including a device, at least one pair of leads coupled to the device configured to extend from the device and attach to an exterior system, and a non-permeable coating configured to provide a vapor barrier surrounding the device and to provide an exposed portion of the pair of leads.

### CROSS-REFERENCE TO RELATED APPLICATIONS

The present application claims priority to and filing benefit of U.S. Provisional Patent Application No. 63/344,758, filed on May 23, 2022, which is incorporated herein by reference in its entirety.

### BACKGROUND

Wearable electronic devices are becoming more ubiquitous as electronics technology approaches smaller feature sizes. Smaller devices enable device incorporation into areas previously thought impossible. Current energy source (e.g., battery) encapsulation systems can be too rigid to conform to the motion of a user wearing a wearable electronic device.

### SUMMARY

There exists a need for energy supplies (e.g., power sources, particularly batteries) to be more amenable to support wearable electronics. In particular, batteries for wearable electronics should be safe and flexible.

According to some aspects of the present disclosure, an electronic device encapsulation includes a non-permeable coating comprising a modulus of elasticity of up to 1 gigaPascals (GPa), and at least a pair of leads coupled to an electronic device and protruding from the non-permeable coating.

According to another aspect, a method of encapsulating an electronic device includes attaching at least a pair of electric leads to the electronic device, coating the electronic device and a portion of each electric lead with a non-permeable coating having an elastic modulus of up to 1 GPa, and curing the non-permeable coating.

According to another aspect, an encapsulated system includes a device, at least a pair of leads coupled to the device configured to extend from the device and attach to an exterior system, and a non-permeable coating comprising a modulus of elasticity of up to 1 gigaPascals (GPa). The non-permeable coating may be configured to provide a vapor barrier surrounding the device and to provide an exposed portion of at least the pair of leads.

Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The accompanying drawings are incorporated herein and form a part of the specification.

FIG. 1 is a digital image of a flexible non-permeable coating according to some embodiments of the present disclosure.

FIG. 2 shows specific capacity test results of an encapsulated battery according to some embodiments of the present disclosure compared to another encapsulated battery.

In the drawings, like reference numbers generally indicate identical or similar elements.

### DETAILED DESCRIPTION

As used herein, the meaning of “a,” “an,” and “the” includes singular and plural references unless the context clearly dictates otherwise.

As used herein, the meaning of “room temperature” or can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

All ranges disclosed herein are to be understood to encompass any and all endpoints as well as any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B and/or C” is intended to mean A alone, B alone, C alone, A and B in combination, A and C in combination, B and C in combination or A, B, and C in combination.

As used herein, the term “surface” refers to the portion of the coating that extends from the exterior face of the coating into an interior of the coating to a depth of up to about 5 μm. Optionally, the surface refers to the portion of the coating that extends into the interior of the coating to a depth of about 0.01 μm, about 0.02 μm, about 0.03 μm, about 0.04 μm, about 0.05 μm, about 0.06 μm, about 0.07 μm, about 0.08 μm, about 0.09 μm, about 0.1 μm, about 0.15 μm, about 0.2 μm, about 0.25 μm, about 0.3 μm, about 0.35 μm, about 0.4 μm, about 0.45 μm, about 0.5 μm, about 0.55 μm, about 0.6 μm, about 0.65 μm, about 0.7 μm, about 0.75 μm, about 0.8 μm, about 0.85 μm, about 0.9 μm, about 0.95 μm, about 1.0 μm, about 1.5 μm, about 2.0 μm, about 2.5 μm, about 3.0 μm, about 3.5 μm, about 4.0 μm, about 4.5 μm, or about 5.0 μm, or anywhere in between. In some examples, the surface extends from the surface to a depth of about 2.0 μm within the interior of the coating.

In certain embodiment, batteries require packaging (e.g., coatings, seals, encapsulations, covers, housings, or the like) that protect the battery from ambient conditions and protect the environment and users from the battery. Accordingly, the encapsulation can serve as a vapor barrier to prevent the ingress of air, moisture, volatile organic compounds (VOCs), or the like into the battery chemistry. Further, battery chemistry can be a delicate balance that is easily disrupted by exposure to air (e.g., oxygen) and moisture. As such, battery packaging can be impermeable to air and moisture ingress. Moreover, for incorporation into wearable electronics, the battery packaging may be able to move with the user wearing the wearable electronics.

In certain embodiments, a flexible non-permeable coating can allow at least one pair of leads coupled to the electronic device to protrude from the flexible non-permeable coating. For example, a first lead can be connected to a positive terminal of the electronic device encapsulated within the coating, and a second lead can be connected to a negative terminal of the encapsulated device, or vice versa. An encapsulated battery can be a packaged battery having power source leads extending from the encapsulation. The power source leads can be designated positive and negative, and configured to be attachable to a device requiring power.

In certain embodiments, the encapsulated device can have a plurality of pairs of leads protruding from the encapsulation. For example, an encapsulated battery can be configured to supply power to multiple electronic device by providing multiple pairs of power source leads from the encapsulated battery.

The flexible non-permeable coating can have a modulus of elasticity (e.g., Young's modulus) of up to about 1 gigaPascal (GPa). For example, the flexible non-permeable coating can have a modulus of elasticity from about 1 megaPascal (MPa) to about 1 GPa, from about 10 MPa to about 1 GPa, from about 10 MPa to about 0.9 GPa (900 MPa), from about 1 MPa to about 0.9 GPa, from about 50 MPa to about 0.75 GPa, from about 1 MPa to about 0.5 GPa, or from about 5 MPa to about 0.5 GPa. In certain embodiments, the flexible non-permeable coating can have a modulus of elasticity up to about 0.5 GPa.

The flexible non-permeable coating can be a vapor barrier that prevents gas and moisture ingress to the electronic device. As used herein, a vapor barrier refers to a material that at least significantly slows the ingress of air and/or moisture from an exterior side of the material to an interior side of the material, and subsequently to the object within the encapsulation to be protected from air and/or moisture. Likewise, the vapor barrier can prevent egress of acids, volatile organic compounds, or the like, present in an electronic device (e.g., a battery). Thus, the flexible non-permeable coating can protect both the battery and the exterior environment and user.

The flexible non-permeable coating can be an elastomer, a latex, a coated fabric, or a combination thereof (e.g., an elastomer that is spray-coatable, dip-coatable, enrober-coatable, panner-coatable, electrostatic-coatable, or any combination thereof, described below). An elastomer is a cross-linked amorphous polymer above its glass transition temperature (T_{g}). The glass transition temperature is a temperature at which a material transitions from exhibiting rigid solid characteristics to exhibiting higher flexibility. The T_{g} is less than a melting temperature (Tₘ) of a material, thus a cross-linked amorphous polymer above its T_{g} behaves as a flexible solid. A latex is a material that exists as a particle dispersion in a medium (e.g., water, oil, oil-in-water, or the like) and the particles form a continuous film upon curing. In certain embodiments, elastomers, latexes, and coated fabrics a sufficiently tight molecular network to block and/or slow the passage of air and/or moisture through the material.

The flexible non-permeable coating can be applied by dip-coating into and/or spray coating from a viscous carrier medium. The viscous carrier medium can be an organic solvent, water, or a combination of solvents that are miscible and a good solvent for the elastomer (e.g., a solvent with a similar solubility parameter to the elastomer). The elastomer and the viscous carrier medium can be a saturated or super-saturated solution. Optional coating methods can include enrobing, panning, or the like.

The flexible non-permeable coating can be a conformal coating that models the exterior topography of the electronic device. In some embodiments, when the flexible non-permeable coating is applied to a battery or other electronic device, the flexible non-permeable coating can adhere to the surface of the battery such that the flexible non-permeable coating models (e.g., mimics or repeats) the surface topography of the battery. For example, a battery can be a pouch-cell battery including an ion source, electrolyte, current collector, an anode, a cathode, and a pair of leads attached to the anode (e.g., the positive terminal) and the cathode (e.g., the negative terminal) positioned within a pouch. When applied, the flexible non-permeable coating can cover ridges found across the surface of the pouch, as well as fill in voids or crevasses found among the ridges. Continued coating (e.g., subsequent dip-coating or continued spraying) can provide for a surface normalization (e.g., smoothing) as the elastomer can flow from peaks to valleys creating a smooth surface contour around the battery or other electronic device.

In certain embodiments, the flexible non-permeable coating can be a compressive non-permeable coating that constricts the electronic device. For example, a compressive non-permeable coating can be a flexible non-permeable coating that constricts or shrinks during curing. In some cases, a compressive non-permeable coating can provide structural support for the battery or other electronic device. The compressive non-permeable coating can add stability to the leads connected to positive and/or negative terminals of the battery/device. In some embodiments, the compressive non-permeable coating can be an enhanced vapor barrier by way of the molecular structure tightening during curing.

In certain embodiments, the device can be any suitable battery (e.g., a pouch cell, a button cell array, a paper battery, a printed battery, a textile battery, or the like). For example, the battery can be a flexible battery (e.g., a pouch cell battery, paper battery, printed battery, or textile battery) or an array of small scale (e.g., having a diameter up to about 10 mm) coin cell batteries. An array of coin cell batteries having diameters ranging from about 4 mm to about 10 mm can be incorporated into an elastomer lamina (e.g., coin cell batteries arranged in an array an laminated with an elastomer) to provide e.g., a power patch. As such, the power patch can incorporate a network of leads connecting the coin cell batteries in series or in parallel. The leads can further be configured to extend beyond a boundary of the power patch (e.g., the elastomer lamina) enabling device connection.

According to another aspect, a method of encapsulating an electronic device including attaching a pair of leads to the device (e.g., attaching a first lead to a positive terminal of the electronic device and attaching a second lead to a negative terminal of the electronic device), coating the device and a portion of each lead with a flexible non-permeable coating, and curing the non-permeable coating.

In some examples, attaching a pair of leads to the device can be performed by soldering, welding, spot welding, twisting, applying a wire nut, or any combination thereof. Attaching at least one pair of leads to the device (e.g., the battery) enables an electrical connection to another device after the battery is encapsulated.

In some embodiments, coating an electronic device can include applying a flexible non-permeable coating around the electronic device. A coating operation can include applying an elastomer, a latex, or a coated fabric around the electronic device. Coating can be performed by dip coating, spray coating, enrober coating, panner coating, vacuum coating, or electrostatic coating. For example, an electronic device can be immersed into an elastomer solution (e.g., the elastomer dissolved in a viscous carrier medium) and withdrawn from the elastomer solution at a rate sufficient to allow the elastomer to adhere to the device. For example, dip coating can be performed at a withdrawal rate of from about 0.1 centimeters per second (cm/s) to about 2 cm/s (e.g., from about 0.1 cm/s to about 1.9 cm/s, from about 0.2 cm/s to about 2 cm/s, from about 0.2 cm/s to about 1.9 cm/s, from about 0.3 cm/s to about 1.75 cm/s, from about 0.5 cm/s to about 1.5 cm/s, or from about 0.25 cm/s to about 1.95 cm/s). For example, the dip coat withdrawal rate can be about 0.1 cm/s, about 0.2 cm/s, about 0.3 cm/s, about 0.4 cm/s, about 0.5 cm/s, about 0.6 cm/s, about 0.7 cm/s, about 0.8 cm/s, about 0.9 cm/s, about 1 cm/s, about 1.1 cm/s, about 1.2 cm/s, about 1.3 cm/s, about 1.4 cm/s, about 1.5 cm/s, about 1.6 cm/s, about 1.7 cm/s, about 1.8 cm/s, about 1.9 cm/s, or about 2 cm/s. In some embodiments, subsequent immersions (e.g., dips) can be performed to provide a smooth exterior elastomer surface.

In certain embodiments, the flexible non-permeable coating can have a thickness of from about 2.5 microns (μm) to about 2 cm (e.g., from about 5 μm to about 100 μm, from about 2.5 μm to about 50 μm, from about 100 μm to about 5 mm, from about 5 μm to about 1 cm, or from about 2.5 μm to about 1 cm). For example, the flexible non-permeable coating can have a thickness of about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95, about 100 μm, about 125 μm, about 150 μm, about 175 μm, about 200 μm, about 300 μm, about 400 μm, about 500 μm, about 600 μm, about 700 μm, about 800 μm, about 900 μm, about 1 mm about 2 mm, about 3 mm, about 4 mm, about 5 mm, about 6 mm, about 7 mm, about 8 mm, about 9 mm, about 10 mm, about 20 mm, about 30 mm, about 40 mm, about 50 mm, about 60 mm, about 70 mm, about 80 mm, about 90 mm, about 1 cm, or about 2 cm.

The method can include applying a conformal coating modeling a surface topography of the electronic device (e.g., modeling the surface topography of the electronic device with an interior of the conformal coating and maintaining a smooth contour surrounding the electronic device with the exterior of the conformal coating). For example, spray coating an elastomer or a latex onto an electronic device having an intricate surface topography can provide a continuous and complete covering regardless of the surface topography of the electronic device. Further, continued spraying can be performed to smooth the exterior surface of the coating. For example, a first spray pass can fill in recessed regions (e.g., valleys, voids, crevasses, or the like) first. Subsequent spray passes can be performed to continue to fill in the recessed regions and/or begin to cover higher and/or protruding regions of the surface of the electronic device. Performing multiple spray passes can provide a fully encapsulated electronic device.

In some embodiments, the coating includes applying a compressive coating. For example, a compressive coating can constrict to the surface of the electronic device as the compressive coating cures. In certain embodiments, as the viscous carrier medium evaporates during curing, the molecular structure of the elastomer can tighten providing the constricting. In some embodiments, the compressive coating can enhance the attachment of the leads to the electronic device and provide connection stability.

Curing can include ambient curing (e.g., room temperature curing), thermal curing, ultraviolet light (UV) curing, or any combination thereof. For example, certain elastomers and latexes can air dry. Optionally, drying can be accelerated by adding heat (e.g., heated air, direct heat, or baking) during curing. In certain examples, the elastomer, or the latex can be a UV-curable polymer that is cross-linked upon exposure to UV light.

In certain embodiments, preventing gas and moisture ingress to the electronic device is performed by employing cross-linked polymers, compressive coatings that constrict and limit air and moisture from penetrating the polymer matrix, and/or hydrophobic coatings. Hydrophobic coatings electrostatically repel water molecules, characterized by a surface water contact angle, thus preventing moisture from penetrating the coating. Cross-linked and constricted materials (e.g., polymers) can prevent air and moisture ingress due to a dense polymer network blocking molecular flow through the material.

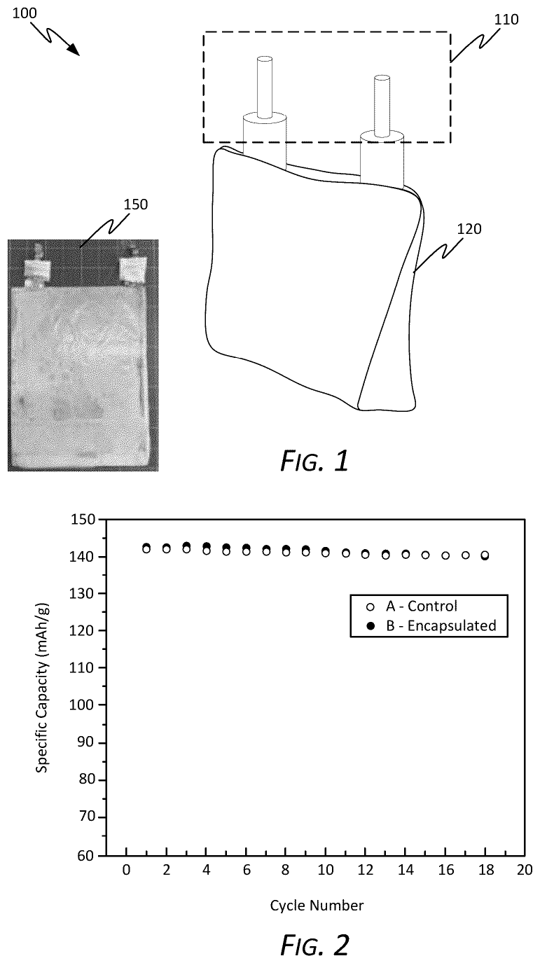

Referencing FIG. 1 and according to another aspect, an encapsulated system 100 includes a device (not shown), at least one pair of leads 110 coupled to the device configured to extend from the device and attach to an exterior system, and a flexible non-permeable coating 120 configured to provide a vapor barrier surrounding the device and provide an exposed portion of the pair of leads. The inset 150 is a digital image of an exemplary encapsulated system 100.

FIG. 2 is a graph showing specific capacity test results of an encapsulated system 100 compared to another encapsulated system. For example, an encapsulated battery having an aluminum covering (referred to as “A-Control” in the example of FIG. 2 and indicated by open circles) was cycled through 18 charge-discharge cycles to evaluate the specific capacity in milliAmpere hours per gram (mAh/g). As shown in the graph, the A-Control encapsulated battery exhibited minimal specific capacity loss over 18 charge-discharge cycles. An encapsulated battery according to certain embodiments of the present disclosure was evaluated under the same charge-discharge cycling. The example encapsulated battery (referred to as “B-Encapsulated” in the example of FIG. 2 and indicated by filled circles) was covered with an elastomer coating as described above. As shown in FIG. 2, the example encapsulated battery performed as well as the control encapsulated battery, exhibiting minimal specific capacity loss over 18 charge-discharge cycles. Thus, encapsulating an electronic device (e.g., a battery) with a flexible non-permeable coating enables wearable battery systems with negligible performance loss compared to currently available battery packs.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. An electronic device encapsulation, comprising:
a non-permeable coating comprising a modulus of elasticity of up to 1 gigaPascals (GPa); and
at least a pair of leads coupled to an electronic device and protruding from the non-permeable coating.

2. The electronic device encapsulation of claim 1, wherein the non-permeable coating is a vapor barrier.

3. The electronic device encapsulation of claim 2, wherein the vapor barrier prevents gas and moisture ingress to the electronic device.

4. The electronic device encapsulation of claim 1, wherein the non-permeable coating comprises an elastomer, a latex, a coated fabric, or a combination thereof.

5. The electronic device encapsulation of claim 4, wherein the elastomer is spray-coatable, dip-coatable, enrober-coatable, panner-coatable, electrostatic-coatable, or any combination thereof.

6. The electronic device encapsulation of claim 1, wherein the non-permeable coating is a conformal non-permeable coating.

7. The electronic device encapsulation of claim 1, wherein the non-permeable coating is a compressive non-permeable coating.

8. The electronic device encapsulation of claim 1, wherein the non-permeable coating comprises a modulus of elasticity of up to 0.5 GPa.

9. The electronic device encapsulation of claim 1, wherein the electronic device is a battery.

10. The electronic device encapsulation of claim 9, wherein the electronic device is a textile battery.

11. A method of encapsulating an electronic device, comprising:
attaching at least a pair of electric leads to the electronic device;
coating the electronic device and a portion of each electric lead with a non-permeable coating having an elastic modulus of up to 1 GPa; and
curing the non-permeable coating.

12. The method of claim 11, wherein the attaching comprises:
attaching at least a first lead to a positive terminal of the electronic device; and
attaching at least a second lead to a negative terminal of the electronic device.

13. The method of claim 11, wherein the coating the electronic device comprises dip coating, spray coating, enrober coating, panner coating, vacuum coating, electrostatic coating, or any combination thereof.

14. The method of claim 11, wherein the coating the electronic device comprises applying an elastomer, applying a latex, or applying a coated fabric.

15. The method of claim 11, wherein the coating the electronic device comprises applying a conformal coating, the conformal coating modeling a surface topography of the electronic device.

16. The method of claim 15, further comprising:
modeling the surface topography of the electronic device with an interior of the conformal coating, and
maintaining a smooth contour surrounding the electronic device using an exterior of the conformal coating.

17. The method of claim 11, wherein the coating the electronic device comprises applying a compressive coating, the compressive coating constricting to a surface of the electronic device.

18. The method of claim 11, wherein the curing the non-permeable coating comprises ambient curing, thermal curing, ultraviolet light (UV) curing, or any combination thereof.

19. The method of claim 11, further comprising preventing gas and moisture ingress to the electronic device.

20. An encapsulated system, comprising:
a device;
at least a pair of leads coupled to the device, the pair of leads configured to extend from the device and attach to an exterior system; and
a non-permeable coating comprising a modulus of elasticity of up to 1 gigaPascals (GPa), the non-permeable coating configured to provide a vapor barrier surrounding the device and provide an exposed portion of at least the pair of leads.
